(19) United States
(12) Patent Application Publication
(10) Pub. No.: US 2012/0031811 A1
(43) Pub. Date: Feb. 9, 2012

(54) SELECTIVE HYDROCRACKING PROCESS FOR EITHER NAPHTHA OR DISTILLATE PRODUCTION

(75) Inventors: Timothy M. Cowan, Sudbury, MA (US); Vedula K. Murty, Willowbrook, IL (US)

(73) Assignee: UOP LLC, Des Plaines, IL (US)

(21) Appl. No.: 12/852,984

(22) Filed: Aug. 9, 2010

(51) Int. Cl. C10G 45/02; B01J 19/00; C10G 47/02

(52) U.S. Cl. 208/57; 208/108; 422/105

(57) ABSTRACT

A hydrocracking zone for the selective production of either a naphtha product stream or a middle distillate stream from a hydrocarbonaceous feedstock utilizing a fixed catalyst and varying the ammonia concentration level introduced to the hydrocracking zone. The ammonia can be obtained by the reaction of nitrogen in the hydrocarbonaceous feedstock in a hydrotreating reactor, or from an external ammonia source, where the ammonia concentration is controlled by a stripping zone which allows an ammonia concentration in the range of about 0 to about 50 wppm to be introduced into the hydrocracking zone to yield a naphtha stream and an ammonia concentration in the range of about 20 to about 200 wppm to be introduced into the hydrocracking zone to yield a middle distillate stream.

### FIELD OF THE INVENTION

This invention generally relates to a process for the selective production of either naphtha or middle distillate from a hydrocarbon feedstock introduced into a hydrocracking zone having a fixed catalyst.

### BACKGROUND OF THE INVENTION

Petroleum refiners often produce desirable products such as turbine fuel, diesel fuel and other products known as middle distillates, as well as lower boiling hydrocarbonaceous liquids such as naphtha and gasoline, by hydrocracking a hydrocarbon feedstock derived from crude oil. Feedstocks most often subjected to hydrocracking are gas oils and heavy gas oils recovered or derived from crude oil by distillation or by thermal or catalytic processes. A typical heavy gas oil comprises a substantial portion of hydrocarbon components boiling above about 371° C. (700° F.), usually at least about 50% by weight boiling above 371° C. (700° F.). A typical vacuum gas oil normally has a boiling point range between about 315° C. (600° F.) and about 565° C. (1050° F.).

Hydrocracking is generally accomplished by contacting the gas oil or other feedstock with a suitable hydrocracking catalyst under conditions of elevated temperature and pressure in the presence of hydrogen so as to yield a product containing a distribution of hydrocarbon products desired by the refiner. The operating conditions and the hydrocracking catalysts chosen within a hydrocracking reactor influence the yield of the hydrocracked products.

Additionally, the hydrocarbon feedstock can first be introduced into a hydrotreating zone to remove various impurities carried in the feedstock, such as nitrogen and sulfur, prior to entering the hydrocracking zone. The term “hydrotreating” can refer to processes wherein a hydrogen-containing treat gas is used in the presence of suitable catalysts which are primarily active for the removal of heteroatoms, such as sulfur and nitrogen and for some hydrogenation of aromatics. The hydrocarbon feedstock often is introduced into the hydrotreating zone along with an additional hydrogen stream in the presence of a hydrotreating catalyst to reform the nitrogen components of the feedstock into ammonia and the sulfur components into hydrogen sulfide.

The hydrotreated effluent stream typically is introduced into a hydrocracking zone over an appropriate catalyst at a temperature and pressure sufficient to cause conversion of the heavy boiling material into lower boiling material.

Alternatively, the hydrotreated effluent stream can first be introduced into a stripping zone at a temperature and pressure sufficient to remove the ammonia and hydrogen sulfide constituents from the stream. The hydrotreated effluent stream then typically is introduced into the hydrocracking zone over an appropriate catalyst at a temperature and pressure sufficient to convert the feedstock into components with lower boiling points.

If the ammonia content of the hydrotreated stream is not adequately reduced in the stripper, then the ammonia impurities can reduce the hydrocracking zone catalyst activity, greatly increasing the temperature required to affect a given level of conversion in the hydrocracking zone. One such adjustment, for example, is to greatly increase the processing temperature to affect a given level of conversion in the hydrocracking zone.

The hydrocracking catalyst and process conditions typically are selected to crack the hydrocarbon feed to a specific, desired product, range of products, and/or product constituents. Once the hydrocracking process is started, the resulting catalyst activity and product selectivity are difficult to modify during the duration of the life of the catalyst, and thus modifying the products or product constituents produced during that hydrocracking run is difficult as well. If a change is desired in the products, range of products and/or product constituents during a hydrocracking run, then production normally must be stopped to change out catalysts or make other similar process changes.

For example, if the operation of the hydrocracker is set up to preferentially yield middle distillate products (e.g., with a boiling point range of about 121° C. (250° F.) to about 399° C. (750° F.)), the hydrocracker would then contain a catalyst appropriate for the production of such products at the required operating conditions. Changing the product output to favor naphtha production (e.g., with a boiling point range of about 10° C. (50° F.) to about 204° C. (400° F.)) would require halting the hydrocracker operation and changing out the catalyst and modifying the process condition accordingly, at considerable expense and loss of production time. One alternative is to adjust the operating conditions, such as temperature and pressure conditions. This typically does not shift the final product yield enough to provide significant amounts of the newly desired products without a complete change out of the hydrocracking catalyst.

### SUMMARY OF THE INVENTION

The process disclosed herein uses the ammonia content present in or added to a feed to a hydrocracking zone to influence the catalyst activity and efficiency thereof to crack a hydrocarbonaceous feedstock to a desired hydrocarbon product, range of products, and/or mix of hydrocarbon constituents, such as those found in middle distillates or naphthas. In one aspect, the ammonia used in the hydrocracking zone is obtained from reacting nitrogen in the hydrocarbonaceous feedstock with a hydrogen stream under hydrotreating conditions and in the presence of hydrotreating catalysts. Therefore, in this aspect, it is not necessary to add ammonia from an external source. However, if desired, an external source of ammonia may be used to supplement, or instead of, the ammonia obtained from the feedstock. This external source of ammonia may be in the form of aqueous ammonia, anhydrous ammonia, or another hydrocarbonaceous feedstock containing nitrogen.

In one aspect, the process (and related apparatus) provide for selective production of a hydrocarbon product stream, from a hydrocarbonaceous feed stream supplied to a hydrocracking zone having a fixed catalyst system. In another aspect, the hydrocarbon product stream may comprise either primarily a naphtha or primarily a middle distillate product stream. The desired products and/or product range are selected by controlling the ammonia concentration introduced into the hydrocracking zone with the hydrocarbonaceous stream. The hydrocracking zone, as a result, is subject to relatively continuous operation without a halt in operations to change the catalyst systems already in use.

The desired product stream can be changed between preferred products during operation of the hydrocracking zone without substantial changes in the initial operating conditions of the hydrocracking zone. The hydrocracking zone may operate at conditions including a temperature from about 204° C. (400° F.) to about 482° C. (900° F.) and a pressure from about 3.4 MPa (500 psig) to about 20.7 MPa (3000 psig), with any number of catalyst systems that are typically used for the production of naphtha or diesel constituents.

Modifying the ammonia concentration in the feed to the hydrocracking zone provides for conversion of the feedstock into a variety of products without requiring a changeover of the existing fixed catalyst system. The activity of the catalyst can be modified depending on the amount of ammonia introduced into the system, and thus the yield of the desired product may be modified according to the activity change in the catalyst that results.

In one aspect, where the ammonia concentration is present from about 0 to about 50 wppm ammonia, primarily a naphtha stream comprising from about 35 to about 70 wt-% naphtha is produced. Where the ammonia concentration is present from about 10 to about 200 wppm, primarily a middle distillate stream is produced comprising from about 20 to about 80 wt-% middle distillate or diesel.

Generally, a high ammonia concentration favors the production of middle distillate, and a low ammonia concentration favors the production of a naphtha product. The ammonia concentration affects the catalyst by slowing down the catalyst activity at high ammonia concentrations (e.g., to yield middle distillate in one aspect) or by having a minimal impact upon catalyst activity with low ammonia concentrations (e.g., to yield naphtha in another aspect). In one aspect, a stripping zone, such as an enhanced hot separator (“EHS”), can drive the ammonia concentration depending upon its process conditions, such as a temperature that ranges from about 148° C. (300° F.) to about 343° C. (650° F.). In the case of naphtha, a lower ammonia concentration is desired and hence a higher temperature in the EHS, i.e., at the higher end of the range, drives the ammonia lower, such that it separates out the ammonia into an overhead stream that does not directly feed into the process. On the other hand, where the middle distillate is desired a lower temperature in the EHS, i.e., a temperature at the lower end of the range, can drive the ammonia into the bottoms liquid product, thus keeping the ammonia concentration high and feeding the effluent containing ammonia into the hydrocracker along with the hydrocarbonaceous feed stream. The hydrocracking zone may operate at conditions including a temperature from about 204° C. (400° F.) to about 482° C. (900° F.) and a pressure from about 3.4 MPa (500 psig) to about 20.7 MPa (3000 psig). The catalyst LHSV ranges from about 0.5 to about 4.0 hr⁻¹.

Prior to entering the hydrocracking zone, the hydrocarbonaceous feedstock may initially be introduced into a hydrotreating zone to treat the feedstock stream with hydrogen to reform any nitrogen components present in the feedstock into ammonia in addition to reforming sulfur components into hydrogen sulfide. This reaction may account for at least a portion of the ammonia source to the hydrocracking zone. The effluent from the hydrotreating zone is then introduced into a stripping zone to remove hydrogen sulfide from the hydrocarbon stream and to reduce the ammonia content of the hydrocarbon stream, as appropriate, to yield the desired final product from the hydrocracker. In another aspect, an external source of ammonia may be used to supplement the ammonia provided from the hydrotreating zone, or as an alternative ammonia source, if needed.

The hydrotreated feedstock also may be directly introduced to a hydrocracking zone prior to stripping. The partially hydrocracked effluent may then be sent to a stripping zone to remove hydrogen sulfide from the hydrocarbon stream and adjust the ammonia content of the hydrocarbon stream, as appropriate, to yield the desired final product from a second hydrocracking zone. The hydrocarbon stream from the stripping zone is introduced into the second hydrocracking zone. In the second hydrocracking zone, the hydrocarbon product stream is cracked to the desired product (e.g., either primarily naphtha or middle distillate products) according to the effect of the ammonia upon the catalyst system and the hydrocarbon zone conditions.

### BRIEF DESCRIPTION OF THE DRAWINGS

FIG. 1 is a graphical representation of the effect of ammonia concentration on turbine fuel yield (e.g., middle distillate).

FIG. 2 is a simplified process flow diagram of a preferred embodiment of the process and processing apparatus described herein.

The above described drawings are intended to be schematically illustrative of the process and apparatus and is not to be a limitation of any invention.

### DETAILED DESCRIPTION

The hydrocracking catalyst activity and thus the product selectivity can be affected by the ammonia concentration in the hydrocracking reaction environment. In one aspect, high ammonia concentrations, e.g., about 10 to 200 wppm, favor middle distillate formation; however, at the expense of efficient catalyst activity. In another aspect, low ammonia concentrations, e.g., about 0 to about 50 wppm, favor naphtha formation while maintaining a high or efficient catalyst activity. The hydrocracking zone catalyst is initially chosen and fixed to produce a specific product. Where it is later desired to change the final product obtained with a particular fixed catalyst but without halting the process and without having to remove and replace the fixed catalyst with one that favors the new product stream, the ammonia concentration to the hydrocracking zone can be adjusted to result in such a change to the product stream without compromising cycle length and without requiring a replacement of the fixed catalyst.

In one aspect of the invention, a hydrocarbonaceous feedstock stream is preferentially cracked to a naphtha boiling range product and/or a middle distillate boiling range product. A naphtha product or product mix typically has a boiling range of about 10° C. (50° F.) to about 204° C. (400° F.) and comprises predominately from about 5 to about 9 carbon atom alkanes, alkenes, and cyclical aromatics. A middle distillate product typically has a boiling point range from about 121° C. (250° F.) to about 399° C. (750° F.) and comprises about 12 or more carbon atom alkanes, alkenes, and cyclical aromatics.

In such an aspect, the feed stream to the hydrocracking zone first passes through a hydrotreating reactor where nitrogen species in the hydrocarbonaceous stream is reacted with a hydrogen stream to produce ammonia. The hydrocarbon and ammonia effluent then are passed through a stripping zone, and the conditions (e.g., temperature and/or pressures) of the stripping zone are selected to remove hydrogen sulfides and other undesirable impurities, as well as excess hydrogen from the effluent, while obtaining or maintaining a desired ammonia content in the effluent stream. Alternatively, the hydrocarbon and ammonia effluent can first be passed through a hydrocracking zone. For example, where the final product desired from the hydrocracker is preferentially naphtha, a lower ammonia concentration may be selected. Where the final product desired is preferentially middle distillate, a higher ammonia concentration may be selected. The hydrocarbon stream is then passed into a hydrocracking zone, and is cracked to the desired product, product mix and/or constituent mix depending upon the catalyst and hydrocracking zone conditions, including the effect of the ammonia content on the particular catalyst system.

In one aspect of the process, a selected feedstock is first introduced into a hydrotreating reaction zone. The feedstock may comprise a hydrocarbonaceous stream such as gas oils and heavy gas oils recovered or otherwise derived from crude oil by distillation or thermal and/or catalytic conversion process. The feedstock fed to the hydrotreating zone can contain nitrogen, thus the hydrogen-containing treat gas can react with the nitrogen species found in the feedstock to convert it into an ammonia compound. However, if desired, an external source of ammonia may be used instead of or to supplement the ammonia obtained from the feedstock. This external source of ammonia could be in the form of aqueous ammonia, anhydrous ammonia, or another hydrocarbonaceous feedstock containing nitrogen. Additionally, additional nitrogen compounds can also be added to or selected for the feedstock to generate a greater quantity of ammonia. A typical heavy gas oil comprises a substantial portion of hydrocarbon components boiling above about 371° C. (700° F.), usually at least about 50 percent by weight boiling above about 371° C. (700° F.). A typical vacuum gas oil normally has a boiling point range between about 315° C. (600° F.) and about 566° C. (1050° F.). The feedstocks may also comprise products from conversion processes such as Fluid Catalytic Crackers (i.e., light cycle oils (“LCO”), heavy cycle oils (“HCO”), clarified slurry oil (“CSO”)), delayed or fluid cokers (coker gas oil (“CGO”), heavy coker gas oil (“HCGO”)), solvent deasphalted stocks (deasphalted oil (“DAO”)), or other thermal and/or catalytic processes which provide hydrocarbonaceous feedstocks within a refinery.

In one aspect, the hydrotreating reaction conditions can include temperatures from about 204° C. (400° F.) to about 482° C. (900° F.), a pressure from about 3.4 MPa (500 psig) to about 20.7 MPa (3000 psig), a liquid hourly space velocity of the fresh hydrocarbonaceous feedstock from about 0.1 to about 10 hr⁻¹ with a hydrotreating catalyst or a combination of hydrotreating catalysts.

Suitable hydrotreating catalysts for use in the present invention are any known conventional hydrotreating catalysts and can include those which are comprised of at least one Group VIII, metal, preferably iron, cobalt and nickel, more preferably cobalt and/or nickel and at least one Group VI metal, preferably molybdenum and tungsten, on a high surface area support material, preferably alumina. Other suitable hydrotreating catalysts can include zeolitic catalysts, as well as noble metal catalysts where the noble metal is selected from palladium and platinum. It is within the scope of the present invention that more than one type of hydrotreating catalyst can be used in the same reaction vessel. The Group VIII, metal can typically be present in an amount ranging from about 2 to about 20 wt-%, preferably from about 4 to about 12 wt-%. The Group VI metal can typically be present in an amount ranging from about 1 to about 25 wt-%, preferably from about 2 to about 25 wt-%. Typical hydrotreating temperatures range from about 204° C. (400° F.) to about 482° C. (900° F.) with pressures from about 3.4 MPa (500 psig) to about 20.7 MPa (3000 psig), and preferably from about 6.9 MPa (1000 psig) to about 17.2 MPa (2500 psig).

In one aspect of the process, the resulting effluent from the hydrotreating reaction zone contains gases and hydrocarbonaceous compounds boiling at a temperature greater than about 10° C. (50° F.), along with hydrogen sulfide and ammonia. The effluent constituents can be partially separated from each other into more than one stream if desired. In one such aspect, the effluent from the hydrotreating zone is introduced into a hot, high pressure stripper where hydrogen sulfide in the effluent is separated and removed to a separate stream from the hydrocarbonaceous compounds. The ammonia content of the effluent stream may be adjusted depending on the desired product, by either separating and removing the undesired ammonia from the hydrocarbonaceous compounds where a naphtha stream is desired or by allowing the ammonia to pass through the stripper or bypass it if a middle distillate is desired. The pressure and temperature of the stripping zone can be maintained such that these parameters are chosen to either separate ammonia from the hydrotreated effluent or to allow it to substantially remain in the effluent, as is necessary to produce the final hydrocracked product.

For example, if selective production of naphtha is desired, then a lower ammonia concentration is preferred, such as about 0 to about 50 wppm. For example, the conditions of the stripping zone can be set to temperatures of about 204° to about 427° C. (about 400° to about 800° F.) and in an aspect about 260° to about 371° C. (about 500° to about 700° F.) to maximize the amount of ammonia removed from the hydrotreated product stream. Pressures in the stripping zone may be about the same as in the hydrotreating reactor. If pressures are changed, different temperature ranges may be applicable to obtain lower ammonia concentration. At these ranges of ammonia, a product stream can be obtained that comprises from about 35 to about 70 wt-% naphtha.

Where selective production of middle distillate products is desired, then a significant ammonia concentration may be required, such as about 10 to about 200 wppm, and the conditions of the stripping zone are modified to minimize the amount of ammonia removed from the hydrotreated effluent. For example, the conditions of the stripping zone can be set to lower temperatures of 93° to about 260° C. (about 200° to about 500° F.) and in an aspect about 149° to about 204° C. (about 300° to about 400° F.) to minimize the amount of ammonia removed from the hydrotreated product stream. Pressures may be about the same as in the hydrotreating reactor. If pressures are changed, different temperature ranges may be applicable to obtain higher ammonia concentration. Alternatively, the stripping zone may be bypassed completely and the ammonia containing stream from the hydrotreating zone can be fed directly into the hydrocracking zone. At these ranges of ammonia, a product stream can be obtained that comprises from about 20 to 80 wt-% middle distillate.

In such an aspect of the process, the resulting hydrocarbonaceous stream from the stripping zone contains hydrocarbonaceous compounds boiling at a temperature greater than about 10° C. (50° F.), hydrogen sulfide and ammonia. The stream can be cooled to a temperature in the range from about 30° C. (86° F.) to about 60° C. (140° F.) and at least a portion of the stream can be introduced into the hydrocracking zone. Fresh make-up hydrogen may be introduced into the process at any suitable and convenient location. Typically, the hydrogen sulfide is separated and removed from the feed stream before it is introduced into the hydrocracking zone. The amount of hydrogen sulfide removed will depend on the specific application and process and product needs. In one example, a significant portion, at least about 90 wt-%, of the hydrogen sulfide is removed and recovered using an appropriate stripping procedure. In another example, the concentration of hydrogen sulfide is reduced to less than about 50 wppm hydrogen sulfide. Reduction of the concentration of hydrogen sulfide to less than about 10 wppm hydrogen sulfide may also be desirable.

At least a portion of the hydrocarbonaceous stream containing hydrocarbonaceous compounds boiling at a temperature greater than about 10° C. (50° F.) is recovered from the stripping zone and introduced into a hydrocracking zone along with added hydrogen. Depending on the final product desired, as previously mentioned, additional ammonia or nitrogen bearing feedstocks may be introduced into the product stream to supplement the ammonia content resulting from the above mentioned hydrotreating step. The additional ammonia may be added in liquid form (e.g., as ammonia hydroxide), gaseous form, or other forms as appropriate for the desired product and the process system.

The ammonia content of the feed stream can be used to influence the performance of the catalysts. When the ammonia concentration is low or nonexistent, the catalyst activity is high in the hydrocracking zone and is relatively unaffected by the low ammonia stream and therefore the high catalyst activity acts efficiently to crack the feed to a lower boiling point hydrocarbon, such as naphtha. When the ammonia levels are high, the catalyst activity slows down, being affected by the high ammonia stream, and thus not cracking as many hydrocarbon chains and producing mostly middle distillate compounds.

Without wishing to be bound by theory, it is believed that the high ammonia levels reduce the number of highly acidic sites on the catalyst, thus reducing the catalyst activity and yielding a primarily middle distillate stream. The more active and, therefore, more acidic the catalyst, such as when the ammonia levels are reduced, the greater its cracking efficiency which results in secondary cracking to a lower boiling point hydrocarbon (i.e., naphtha).

As discussed above in one aspect, where middle distillate is desired, the feed stream to the hydrocracking zone may have a relatively high total ammonia content, such as between about 20 and about 200 wppm, yielding at least about 40% middle distillate. In this aspect, the stripping zone can either be bypassed entirely or operated at a sufficiently low temperature to retain a substantial amount of ammonia and H₂S in the stream. In another aspect, if naphtha is desired then the feed stream may contain from about 0 to about 50 wppm ammonia, yielding at least about 25% naphtha. In that aspect, the stripping zone can be operated to remove a substantial amount of ammonia and H₂S prior to the stripping zone effluent being introduced to the hydrocracking zone. As a result of the low ammonia concentration, the conversion of the feed stream to the hydrocracking zone would be increased to produce naphtha. If a two-stage hydrocracking zone is utilized, the bottoms (e.g., which would comprise middle distillate or diesel) can be recirculated to a second-stage reactor also operating at a lower ammonia concentration in order to further convert the stream to naphtha. Furthermore, additional elements may be required such as an additional quench gas, such as a hydrogen-rich gas, make-up hydrogen, debutanizer and fractionation capacity to efficiently shift the final product stream to the new product stream.

In such aspects of the process, the hydrocracking zone may contain one or more beds of the same catalysts or of different fixed catalysts, which respond to modification in conversion and/or reaction characteristics of the final product with ammonia changes. In one aspect, when the desired products are diesel, or middle distillates, the preferred hydrocracking catalysts utilize amorphous bases or low-level zeolite bases combined with one or more Group VIII or Group VIB metal hydrogenating components. In another aspect, when the preferred products are in the gasoline, or naphtha boiling ranges, the hydrocracking zone contains a catalyst which comprises, in general, any crystalline zeolite cracking base upon which is deposited a minor proportion of a Group VIII, metal hydrogenating component.

Additional hydrogenating components may be selected from Group VIB for incorporation with the zeolite base. The zeolite cracking bases are sometimes referred to in the art as molecular sieves and are usually composed of silica, alumina and one or more exchangeable cations such as sodium, magnesium, calcium, rare earth metals, and the like. They are further characterized by crystal pores of relatively uniform diameter between about 4 and 14 Angstroms (10⁻¹⁰ meters). It is preferred to employ zeolites having a relatively high silica/alumina mole ratio between about 3 and 12. Suitable zeolites found in nature include, for example, mordenite, stilbite, heulandite, ferrierite, dachiardite, chabazite, erionite and faujasite. Suitable synthetic zeolites include, for example, the B, X, Y and L crystal types, e.g., synthetic faujasite and mordenite. The preferred zeolites are those having crystal pore diameters between about 8 and 12 Angstroms (10⁻¹⁰ meters), wherein the silica/alumina mole ratio is about 4 to 6. A prime example of a zeolite falling in the preferred group is synthetic Y molecular sieve.

The natural occurring zeolites are normally found in a sodium form, an alkaline earth metal form, or mixed forms. The synthetic zeolites are nearly always prepared first in the sodium form. In any case, for use as a cracking base it is preferred that most or all of the original zeolitic monovalent metals be ion-exchanged with a polyvalent metal and/or with an ammonium salt followed by heating to decompose the ammonium ions associated with the zeolite, leaving in their place hydrogen ions and/or exchange sites which have actually been decationized by further removal of water. Hydrogen or “decationized” Y zeolites of this nature are more particularly described in U.S. Pat. No. 3,130,006.

Mixed polyvalent metal-hydrogen zeolites may be prepared by ion-exchanging first with an ammonium salt, then partially back exchanging with a polyvalent metal salt and then calcining. In some cases, as in the case of synthetic mordenite, the hydrogen forms can be prepared by direct acid treatment of the alkali metal zeolites. The preferred cracking bases are those which are at least about 10 percent, and preferably at least 20 percent, metal-cation-deficient, based on the initial ion-exchange capacity. A specifically desirable and stable class of zeolites are those wherein at least about 20 percent of the ion exchange capacity is satisfied by hydrogen ions.

The active metals employed in the preferred hydrocracking catalysts of the present invention as hydrogenation components are those of Group VIII, i.e., iron, cobalt, nickel, ruthenium, rhodium, palladium, osmium, iridium and platinum. In addition to these metals, other promoters may also be employed in conjunction therewith, including the metals of Group VIB, e.g., molybdenum and tungsten. The amount of hydrogenating metal in the catalyst can vary within wide ranges. Broadly speaking, any amount between about 0.05 and 30 wt-% may be used. In the case of the noble metals, it is normally preferred to use about 0.05 to about 2 wt-%. The preferred method for incorporating the hydrogenating metal is to contact the zeolite base material with an aqueous solution of a suitable compound of the desired metal wherein the metal is present in a cationic form. Following addition of the selected hydrogenating metal or metals, the resulting catalyst powder is then filtered, dried, pelleted with added lubricants, binders or the like if desired, and calcined in air at temperatures of, e.g., about 700° to about 1200° F. (about 371° to about 648° C.) in order to activate the catalyst and decompose ammonium ions. Alternatively, the zeolite component may first be pelleted, followed by the addition of the hydrogenating component and activation by calcining.

The foregoing catalysts may be employed in undiluted form, or the powdered zeolite catalyst may be mixed and copelleted with other relatively less active catalysts, diluents or binders such as alumina, silica gel, silica-alumina cogels, activated clays and the like in proportions ranging between 5 and 90 wt-%. These diluents may be employed as such or they may contain a minor proportion of an added hydrogenating metal such as a Group VIB and/or Group VIII metal. Additional metal promoted hydrocracking catalysts may also be utilized in the process of the present invention which comprises, for example, aluminophosphate molecular sieves, crystalline chromosilicates and other crystalline silicates.

In such aspects, selection of the hydrocracking catalysts and operating parameters influences the catalyst activity, efficiency and selectivity and therefore product output from the hydrocracking zone, in terms of the mix of hydrocarbon constituents of the output stream, (e.g., the hydrocarbon chain length distribution, the alkane and naphtha content, etc.).

In another aspect, the hydrocracking of the hydrocarbonaceous feedstock in contact with a hydrocracking catalyst in the hydrocracking zone can be conducted in the presence of hydrogen and preferably at hydrocracking reactor conditions which include a temperature from about 204° C. (400° F.) to about 482° C. (900° F.), a pressure from about 3448 kPa gauge (500 psig) to about 20685 kPa gauge (3000 psig), a liquid hourly space velocity (LHSV) from about 0.1 to about 10 hr⁻¹, and a hydrogen circulation rate from about 337 to about 4200 normal m³/m³ (about 2000 to about 25,000 standard cubic feet per barrel). In one aspect, the per pass conversion in the hydrocracking zone can be in the range from about 30% to about 80%. More preferably, the per-pass conversion can be in the range from about 40% to about 70%.

### Example

A vacuum gas oil (“VGO”) range hydrocarbonaceous feed is first hydrotreated, and then introduced into a stripping zone where the effluent from the hydrotreating zone is stripped of ammonia and hydrogen sulfide, in a first example, and partially stripped in a second example. The remaining liquid stream is then sent to a hydrocracking zone over a low zeolite containing hydrocracking catalyst where the liquid stream is cracked into substantially a middle distillate stream. The effluent of the hydrocracking reactor is then sent to a fractionation zone for separation into various products by their boiling point ranges. Compounds boiling higher than the turbine range, and even typically higher than the middle distillate range, are recycled in part back to the hydrocracking zone. Turbine fuel is a subset of the middle distillate stream and is the lightest fraction of the middle distillate. The middle distillate can encompass the boiling range of both turbine fuel and diesel, therefore the compounds boiling higher than the turbine range would be the remaining fractions of the middle distillate, such as the diesel.

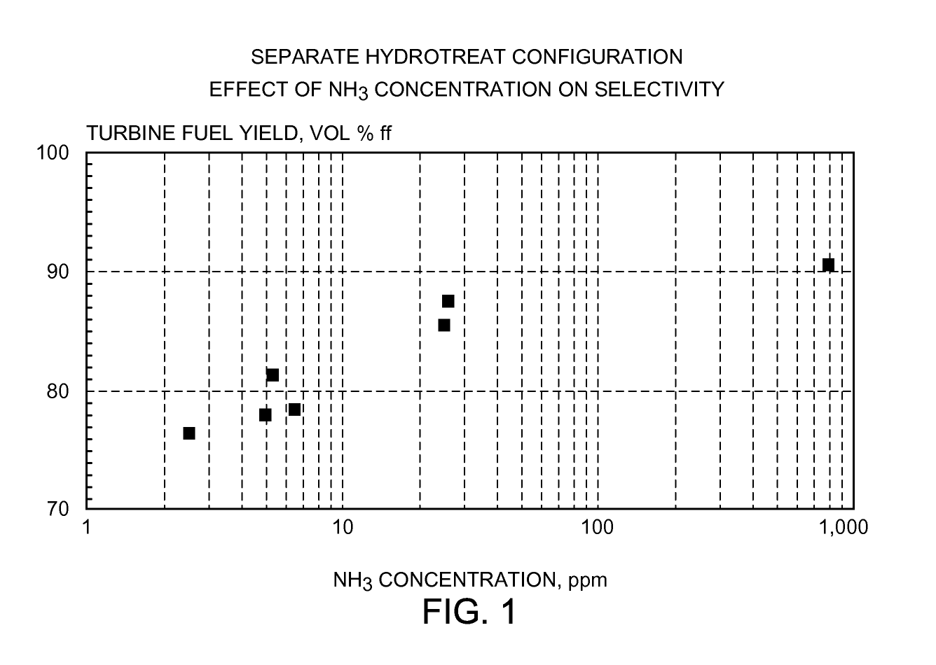

FIG. 1 compares turbine fuel yield by volume percent based on fresh feed as a function of ammonia concentration. The feed contained 30 to 60 wppm hydrogen sulfide. Lower ammonia concentrations hovering around 3 wppm yielded less turbine fuel between 77 and 82 vol-%. Higher ammonia concentrations controlled to about 25 wppm yielded greater turbine fuel in the range of 86 to 88 vol-%. For one data point, ammonia concentration was about 800 wppm which would be attributable to a hydrotreated effluent that has bypassed the stripper entirely. It yielded over 90 vol-% turbine fuel. Therefore, it was evident that as ammonia concentration increased, product selectivity to diesel increased due to a decrease in catalyst activity.

It was also noted that the operating temperature to effect the same level of conversion was lower for lower ammonia concentrations and higher for higher ammonia concentrations.

### DETAILED DESCRIPTION OF THE DRAWINGS

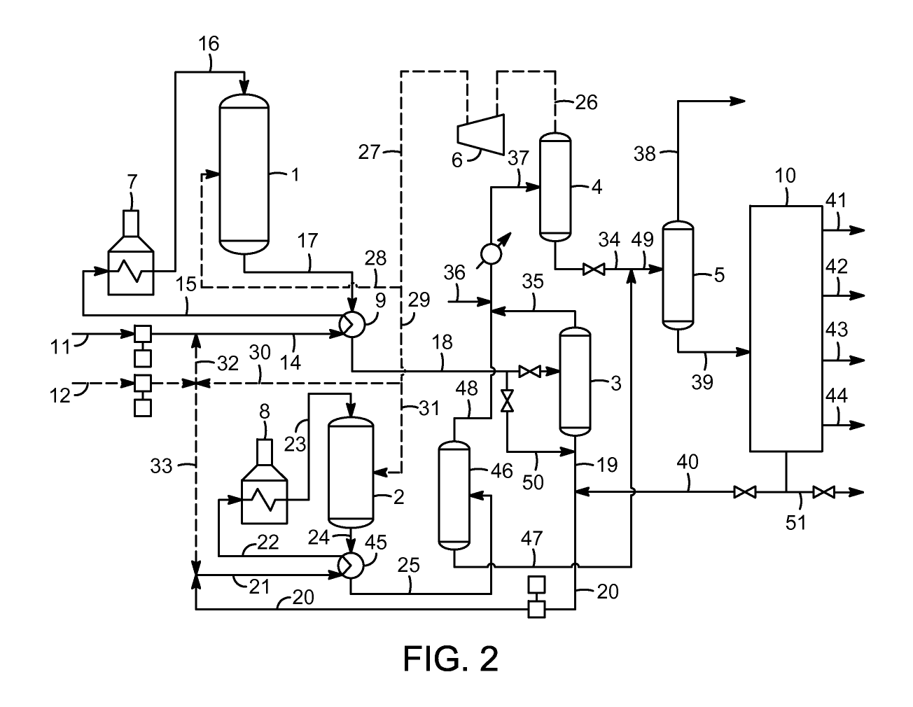

FIG. 2 is a simplified process flow diagram of a preferred embodiment of the present invention. The drawing is intended to be schematically illustrative of the present invention and not to be a limitation thereof.

A feed stream comprising a hydrocarbonaceous stream, such as a vacuum gas oil stream or a distillate stream, is introduced into the process via line 11. A hydrogen feed in line 12 can also be combined directly with the feed stream in line 11 via line 32. Gas lines are depicted as dashed lines. The admixture of feed and hydrogen is transferred into the process via line 14.

The resulting admixture is transported via line 14 into a heat exchanger 9. The resulting effluent from heat exchanger 9 is transported to a heater 7 via line 15 and the heated stream is passed into the hydrotreater 1 via line 16. The effluent from the hydrotreater 1 is transported via line 17 and introduced into heat exchanger 9. The resulting effluent is introduced into a separator 3 which may be a stripping zone and can be an enhanced hot separator, via line 18 and the stream is split into an overhead stream comprising primarily light hydrocarbons and hydrogen, designated by line 35, and a bottom stream comprising primarily heavy hydrocarbons, or a liquid product stream, and designated by line 19. The hydrotreated feed may be stripped by a gas such as hydrogen or steam in the separator 3 or not. The liquid product stream is removed from the bottom of the separator 3 via line 19. Alternatively, the separator 3 may be bypassed completely via line 50 and the ammonia containing stream from the hydrotreating zone can be fed directly into the hydrocracking zone. In this alternative case, the control valve on line 18 would be closed and the control valve on line 50 would be opened, so the separator 3 would be effectively bypassed, such that line 19 carries both gases and hydrotreated oil. In this alternative, no flow would travel through line 35.

The liquid product stream in line 19 is optionally admixed with a hereinafter described product separator recycle effluent transported via line 40 and/or optionally admixed with the hydrotreated feed from line 18 which bypasses separator 3, where the resulting admixture is carried by line 20. The resulting admixture consists of the liquid product stream of line 19 and the optional recycle stream comprising heavy hydrocarbons and/or the hydrotreated feed stream 50 and is combined with a hereinafter described hydrogen stream transported via line 33, the resulting admixture is then transported via line 21 to heat exchanger 45 and the effluent from the heat exchanger 45 is then introduced into a heater 8 via line 22. The stream exiting the heater 8 is then introduced into the hydrocracker 2 via line 23.

The hydrotreated feed stream is introduced into the hydrocracker 2, via line 23, and an additional hydrogen stream may also be introduced into the hydrocracker 2 via line 31. The effluent from the hydrocracker 2 is then introduced into the heat exchanger 45 via line 24 and exits via line 25. The hydrocracker effluent from the heat exchanger 45 is then passed through a hot high pressure separator 46, where the bottom stream 47 from the separator 46 comprises primarily heavy hydrocarbons and is fed into the separator 5 which may be a stripper via line 49. If used as a stripper, steam may be fed into a lower end of the stripper to assist the separation. The overhead stream 48 from the separator 46 is comprised primarily of distillates and lighter hydrocarbons and is combined with the effluent in an overhead line designated 35 from the top of the stripper 3, which can be an enhanced hot separator, and further combines with a water wash via line 36 and the resultant mixture is then cooled and introduced into a cold separator 4 via line 37. The bottoms effluent from the cold separator 4, comprising mainly light naphtha and heavier hydrocarbons, passes into the separator 5 via line 34 and 49, while the overhead stream 26 comprising recycle gas exits the cold separator 4 via line 26 and passes through a compressor 6. The effluent bottoms stream 34 combines with the effluent bottoms stream 47 from the separator 46 and the resultant mixture is introduced into the separator 5 via line 49 and is separated in the separator 5 into an effluent bottoms stream rich in naphtha and distillates via line 39, and an overhead vent gas stream via line 38. The effluent bottoms stream in line 39 is then introduced into the product separator 10, where the effluent bottoms stream is separated into butanes, at line 41, naphtha, at line 42, light/medium distillate at line 43, and medium/heavy distillate at line 44. A stream of heavy hydrocarbon is provided from the bottom of the product separator 10. A recycle stream of heavy hydrocarbon is optionally recycled back to the beginning of the hydrocracking process via line 40 by introducing it into the bottom effluent from stripper 3. If heavy hydrocarbon is recycled, the control valve on line 40 is open. The heavy hydrocarbon not recycled in line 40 may be recovered as product in line 51. Recovered heavy product passes through open control valve on line 51.

The optional recycle stream at line 40 is admixed with the product stream in line 19 and the admixture is transferred via line 20. The hydrogen feed introduced at line 12 can be transferred via line 33 and combined with the recycle stream and stripper bottoms at line 21, which can then continue through the process and into the hydrocracker 2.

The cold separator 4 has a top stream comprising a recycle gas which exits the cold separator 4 via line 26 and goes through the compressor 6. The recycle gas stream passes through the compressor 6, exiting via line 27 and can be introduced into the hydrotreater 1 via line 28, and/or can be introduced into the hydrocracker 2 via lines 29 and 31. Still another option for the stream 27 exiting the compressor 6, is to combine the stream 27 with the hydrogen feed stream 12, such that the recycle gas stream is transported via line 30 to form an admixture with the hydrogen at either lines 32 and/or line 33, where in the former it will be transported with the hydrogen to the hydrotreater 1 and in the latter line it will be transported with the hydrogen to the hydrocracker 2.

The foregoing description and drawings clearly illustrate the advantages encompassed by the process of the present invention and the benefits to be afforded with the use thereof.

1. A method for selectively hydrocracking a hydrocarbonaceous feed stock in a continuous method comprising:
providing a hydrocracking zone having a fixed, hydrocracking catalyst system operating at predetermined temperature and pressure conditions, the catalyst system having a catalyst activity in the presence of a hydrocarbonaceous feed with at least a first ammonia content effective to produce first hydrocracked products having a first boiling point range, and the catalyst system having a catalyst activity in the presence of a hydrocarbonaceous feed with at least a second ammonia content effective to produce second hydrocracked products having a second boiling point range;
providing a hydrocarbonaceous feed having an ammonia content, and passing the feed into the hydrocracking zone over the catalyst system to produce a hydrocracked product effluent; and
adjusting the ammonia content of the hydrocarbonaceous feed to produce a hydrocracked effluent from the hydrocracking zone having a minimum amount of at least the first hydrocracked products and a minimum amount of at least the second hydrocracked products, the composition of the hydrocracked effluent adjusted without substantial interruption of the operation of the hydrocracking zone and without substantial increase in the hydrocracking zone temperatures and pressures.

2. The method of claim 1 wherein the ammonia content of the hydrocarbonaceous feed passed into the hydrocracking zone is adjustable from about 0 to about 50 wppm to produce a hydrocracked effluent comprising at least about 25% naphtha, and the ammonia content is adjustable from about 20 to about 200 wppm to produce a hydrocracked product comprising at least about 40% middle distillates without substantial interruption of the operation of hydrocracking zone and without substantial increases in the hydrocracking zone temperatures or pressures.

3. The method of claim 2 wherein the hydrocracking zone operates at temperatures from about 204° C. (400° F.) to about 482° C. (900° F.), at pressures from about 3.4 MPa (500 psig) to about 20.7 MPa (3000 psig), and at liquid hourly space velocities from about 0.1 to about 10 hr⁻¹.

4. The method of claim 1 comprising providing at least a portion of the hydrocarbonaceous feed ammonia content by passing a hydrocarbonaceous feed containing nitrogen constituents through a hydrotreating zone upstream of the hydrocracking zone, the hydrotreating zone converting the nitrogen constituents to ammonia constituents.

5. The method of claim 4 wherein the ammonia content of the hydrocarbonaceous feed to the hydrocracker is supplemented by a feed of ammonia constituents into the hydrotreated effluent.

6. The method of claim 4 comprising passing the hydrotreated effluent through a separator upstream of the hydrocracking zone, the separator removing sulfur compositions and other contaminants from the hydrotreated effluent and removing ammonia in excess of the adjusted ammonia content of the hydrocarbonaceous feed to the hydrocracking zone.

7. The method of claim 6 wherein the separator is adjusted between a temperature of about 149 and about 204° C. (300 to 400° F.) to remove less ammonia and a temperature of about 260 to about 371° C. (500 to 700° F.) to remove more ammonia.

8. The method of claim 1 wherein the hydrocarbonaceous feed ammonia content is adjusted by introducing ammonia constituents into the hydrocarbonaceous feed from a source external to the hydrocarbonaceous feed.

9. The method of claim 8 wherein the ammonia content of the hydrocarbonaceous feed is adjusted in the hydrocracking zone using ammonia constituents from the external source.

10. The method of claim 1 wherein the hydrocarbonaceous feed comprises a heavy gas oil with hydrocarbon constituents comprising at least 50 percent by weight of the feed and has a boiling point above about 371° C. (700° F.), or a vacuum gas oil with a boiling point range between about 315° C. (600° F.) and about 565° C. (1050° F.).

11. The method of claim 1 wherein hydrocarbonaceous feed comprises light cycle oils, heavy cycle oils, clarified slurry oil, delayed or fluid cokers, heavy coker gas oil, or solvent deasphalted stocks.

12. A hydrocracking method for the selective production of either naphtha or a middle distillate comprising:
passing a hydrocarbonaceous feedstock into a hydrotreating zone and treating the feed stock with hydrogen to react with nitrogen present in the feedstock to form ammonia constituents;
passing the feedstock and ammonia constituents into a separator, where contaminants and a portion of the ammonia constituents are separated from the feedstock;
passing the feedstock and ammonia constituents into a hydrocracking zone with a fixed catalyst system at temperatures from about 204° C. (400° F.) to about 482° C. (900° F.), and pressures from about 3.4 MPa (500 psig) to about 20.7 MPa (3000 psig); and
adjusting the ammonia constituent concentration introduced into the hydrocracking zone to select a final product effluent comprising primarily at least about 25% naphtha when an ammonia level is present from about 0 to about 50 wppm and comprising primarily at least 40% middle distillate when the ammonia level is from about 20 to about 200 wppm.

13. The method of claim 12 wherein the naphtha has a boiling point range of from about 10° C. (50° F.) to about 204° C. (400° F.), and the middle distillates have a boiling point range of from about 121° C. (250° F.) to about 399° C. (750° F.).

14. The method of claim 12 wherein the ammonia constituent concentration of the feedstock is supplemented with additional ammonia constituents from another source.

15. The method of claim 12 wherein the hydrocarbonaceous feed is a heavy gas oil with hydrocarbon constituents comprising at least 50 percent by weight of the feed and has a boiling point above about 371° C. (700° F.) or vacuum gas oil with a boiling point range between about 315° C. (600° F.) and about 565° C. (1050° F.).

16. A system for the selective production of either naphtha or a middle distillate from a heavy gas oil or vacuum gas oil comprising:
a hydrotreating zone, with a feed line directing a hydrocarbonaceous stream into the hydrotreating zone, and a hydrogen source in communication with the hydrotreating zone to provide a hydrogen stream to react with nitrogen constituents present in the feedstock to form ammonia constituents;
a feed line directing the hydrotreated feedstock and ammonia constituents to a stripper, the stripper configured to remove contaminants and a portion of the ammonia constituents from the feedstock;
a feed line from the stripper to a hydrocracking zone, the hydrocracking zone having a fixed catalyst system adapted for operation at temperatures from about 204° C. (400° F.) to about 482° C. (900° F.), and pressures from about 3.4 MPa (500 psig) to about 20.7 MPa (3000 psig); and
controllers monitoring and adjusting the ammonia constituent concentration of the feedstock introduced in the hydrocracking zone to provide a final product effluent comprising at least about 25% naphtha when an ammonia level is present from about 0 to about 50 wppm and comprising at least 40% middle distillate when the ammonia level is from about 20 to about 200 wppm.
